(19) United States
(12) Patent Application Publication
(10) Pub. No.: US 2019/0340496 A1
(43) Pub. Date: Nov. 7, 2019

(54) INFORMATION PROCESSING APPARATUS AND INFORMATION PROCESSING METHOD

(71) Applicant: Panasonic Intellectual Property Corporation of America, Torrance, CA (US)

(72) Inventors: MIN YOUNG KIM, San Jose, CA (US); SOTARO TSUKIZAWA, Osaka (JP)

(21) Appl. No.: 16/516,838

(22) Filed: Jul. 19, 2019

Related U.S. Application Data
(63) Continuation of application No. PCT/JP2018/010954, filed on Mar. 20, 2018.
(60) Provisional application No. 62/478,738, filed on Mar. 30, 2017.

(51) Int. Cl. G06N 3/04

(52) U.S. Cl. CPC G06N 3/0445; G06N 3/088

(57) ABSTRACT

An information processing apparatus includes an inputter, a comparison processor, and an outputter. The inputter inputs, in a neural network, a first data item that is one of data items included in time-series data. The comparison processor performs comparison between a first predicted data item predicted by the neural network and a second data item that is included in the time-series data. The first predicted data item is predicted as a data item first time after the first data item. The second data item is a data item the first time after the first data item. The outputter outputs information indicating warning if an error between the second data item and the first predicted data item is larger than a threshold after the comparison processor performs the comparison.

### BACKGROUND

### 1. Technical Field

The present disclosure relates to an information processing apparatus and an information processing method and particularly relates to an information processing apparatus and an information processing method that use a neural network.

### 2. Description of the Related Art

Neuroscience has the concept of “predictive coding” in which the brain continuously predicts sensory irritancy.

In recent years, artificial neural networks based on the concept have been studied (for example, W. Lotter, G. Kreiman, and D. Cox, “Deep predictive coding networks for video prediction and unsupervised learning,” CoRR abs/1605.08104 (2016)).

Lotter (ibid.) proposes an artificial neural network named Deep Predictive Coding Network (hereinafter, referred to as a Pred Net). The artificial neural network is capable of unsupervised video prediction learning. According to Lotter (ibid.), upon receiving an image of one of frames included in video, the Pred Net having performed learning can predict and generate an image of the subsequent frame.

### SUMMARY

In one general aspect, the techniques disclosed here feature an information processing apparatus including an inputter, a comparison processor, and an outputter. The inputter inputs, in a neural network, a first data item that is one of data items included in time-series data. The comparison processor performs comparison between a first predicted data item predicted by the neural network and a second data item that is included in the time-series data. The first predicted data item is predicted as a data item first time after the first data item. The second data item is a data item the first time after the first data item. The outputter outputs information indicating warning if an error between the second data item and the first predicted data item is larger than a threshold after the comparison processor performs the comparison.

The information processing apparatus and the like of the present disclosure enable a risk situation to be predicted by using a neural network.

It should be noted that these general or specific aspects may be implemented as a system, a method, an integrated circuit, a computer program, a computer readable recording medium such as a compact disc read-only memory (CD-ROM), or any selective combination thereof.

Additional benefits and advantages of the disclosed embodiments will become apparent from the specification and drawings. The benefits and/or advantages may be individually obtained by the various embodiments and feature of the specification and drawings, which need not all be provided in order to obtain one or more of such benefits and/or advantages.

### BRIEF DESCRIPTION OF THE DRAWINGS

FIG. 1 is a block diagram illustrating an example configuration of an information processing apparatus in an embodiment;

FIG. 2 is a block diagram illustrating an example of the detailed configuration of a comparison processor illustrated in FIG. 1;

FIG. 3A is a diagram illustrating the structure of a network model of a Pred Net and information flow;

FIG. 3B is a diagram illustrating the module structure of each of the layers of the Pred Net;

FIG. 4 is a diagram illustrating an example result of prediction by the neural network in the embodiment;

FIG. 5 is a diagram illustrating an example result of prediction by the neural network in the embodiment;

FIG. 6 is a diagram for explaining an example of a comparison process executed by a comparer in the embodiment;

FIG. 7 is a diagram illustrating an example of an error output as a comparison process result by the comparison processor in the embodiment;

FIG. 8 is a diagram illustrating an example of the error output as a comparison process result by the comparison processor in the embodiment;

FIG. 9 is a diagram illustrating an example of the error output as a comparison process result by the comparison processor in the embodiment;

FIG. 10 is a diagram illustrating an example of the error output as a comparison process result by the comparison processor in the embodiment; and

FIG. 11 is a flowchart for explaining operation of the information processing apparatus in the embodiment.

### DETAILED DESCRIPTION

### Underlying Knowledge Forming Basis of the Present Disclosure

Lotter (ibid.) merely discloses that the Pred Net is capable of the unsupervised learning and directly predicting a next frame image from an input image. That is, how the Pred Net is applied is not disclosed.

A neural network such as the Pred Net is capable of predicting a future data item such as the next frame from an actual data item such as the current frame and thus is considered to be likely applicable to risk situation prediction in various fields such as automatic driving and a monitoring system.

The present disclosure has been made under the above-described circumstances and provides an information processing apparatus and an information processing method that are enabled to predict a risk situation by using a neural network.

An information processing apparatus according to an embodiment of the present disclosure includes an inputter, a comparison processor, and an outputter. The inputter inputs, in a neural network, a first data item that is one of data items included in time-series data. The comparison processor performs comparison between a first predicted data item predicted by the neural network and a second data item that is included in the time-series data. The first predicted data item is predicted as a data item first time after the first data item. The second data item is a data item the first time after the first data item. The outputter outputs information indicating warning if an error between the second data item and the first predicted data item is larger than a threshold after the comparison processor performs the comparison.

This enables a risk situation to be predicted by using the neural network.

For example, the time-series data is video data, and the first data item, the first predicted data item, and the second data item are image data items.

For example, the comparison processor may perform comparison among the first predicted data item, a second predicted data item, and a third data item that is included in the time-series data. The second predicted data item is predicted by the neural network as a data item second time after the first data item. The second time is time the first time after the first time. The third data item is a data item the second time after the first data item. If an average of the error between the second data item and the first predicted data item and an error between the third data item and the second predicted data item is larger than a threshold after the comparison processor performs the comparison, the outputter may output the information.

For example, the neural network includes a recurrent neural network.

For example, the neural network has at least one convolutional long-short-term-memory (LSTM) and at least one convolutional layer. The at least one convolutional LSTM is the recurrent neural network.

For example, the neural network is a Pred Net. The recurrent neural network is a convolutional LSTM included in the Pred Net.

An information processing method according to an embodiment of the present disclosure is an information processing method performed by a computer by using a neural network. The method includes: inputting, in the neural network, a first data item that is one of data items included in time-series data; performing a comparison process in which comparison between a first predicted data item predicted by the neural network and a second data item that is included in the time-series data is performed, the first predicted data item being predicted as a data item first time after the first data item, the second data item being a data item the first time after the first data item; and outputting information indicating warning if an error between the second data item and the first predicted data item is larger than a threshold after the comparison is performed in the performing of the comparison process.

Embodiments described below each illustrate a specific example of the present disclosure. Numerical values, shapes, components, steps, the order of the steps, and the like that are described in each embodiment below are merely examples and do not limit the present disclosure. If a component among components in the embodiments that is not described in an independent claim corresponding to the highest level description of the present disclosure is described in the following embodiments, the component is described as an optional component. The content of any of the embodiments may be combined.

### Embodiments

Hereinafter, an information processing method and the like performed by an information processing apparatus 10 in an embodiment will be described with reference to the drawings.

### Configuration of Information Processing Apparatus 10

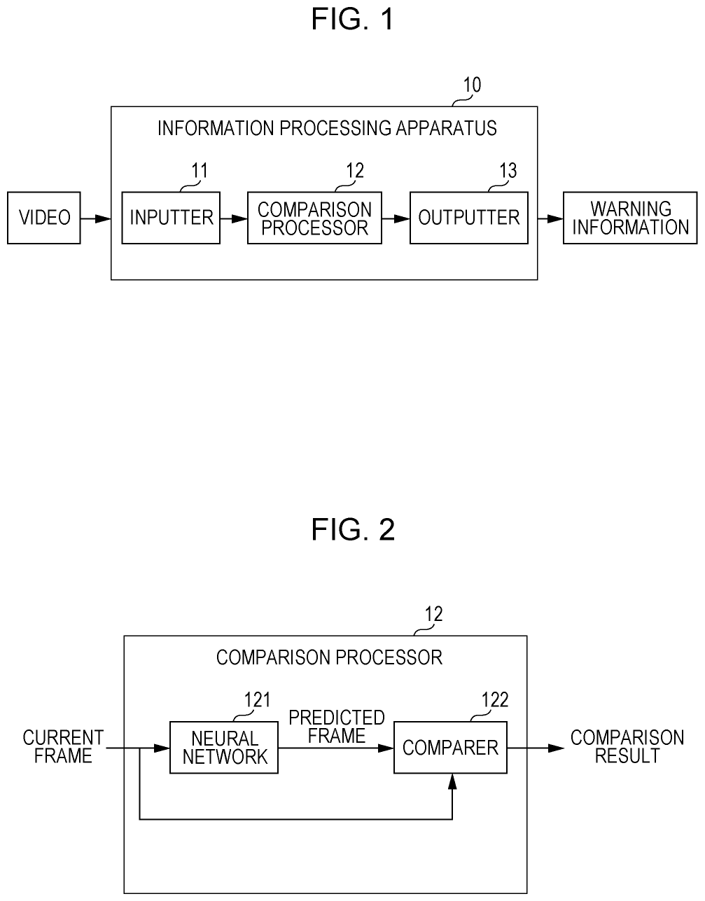

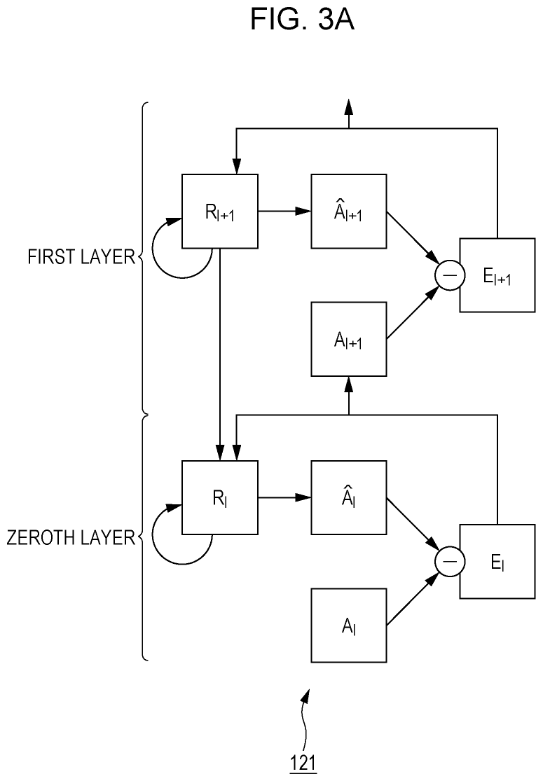

FIG. 1 is a block diagram illustrating an example configuration of the information processing apparatus 10 in this embodiment. FIG. 2 is a block diagram illustrating an example of the detailed configuration of a comparison processor 12 illustrated in FIG. 1.

The information processing apparatus 10 is implemented by a computer or the like using a neural network and includes an inputter 11, the comparison processor 12, and an outputter 13, as illustrated in FIG. 1. When a situation unexpected in the input video is to occur, the information processing apparatus 10 outputs warning information. The comparison processor 12 includes a neural network 121 and a comparer 122, as illustrated in FIG. 2.

### Inputter 11

The inputter 11 inputs, in the neural network 121, a first data item that is one of data items included in time-series data. More specifically, the inputter 11 first inputs the first data item included in the time-series data in the comparison processor 12 and subsequently inputs a second data item included in video data in the comparison processor 12. The time-series data has data items continuous in a time series and has tendency. For example, the time-series data may be video composed of images continuous in a time series, may represent the content of conversation continuous in a time series made by two persons, or may be sound continuous in a time series in a predetermined place. The second data item is temporally continuous with the first data item and is a data item following the first data item. More specifically, the second data item is included in the time-series data and is a data item first time after the first data item. The first time is an interval between two or more data items included in the time-series data, and is, for example, an interval within one second.

The following description assumes that the time-series data is video data and the first data item and the second data item are image data items. In this embodiment, the inputter 11 first inputs the first data item included in the time-series data as the current frame in the comparison processor 12 and subsequently inputs the second data item included in the video data as the current frame in the comparison processor 12.

### Comparison Processor 12

The comparison processor 12 compares a first predicted data item with the second data item. The first predicted data item is predicted by the neural network 121 as a data item the first time after the first data item. The second data item is included in the time-series data and is a data item the first time after the first data item. More specifically, as illustrated in FIG. 2 and as described above, the comparison processor 12 includes the neural network 121 and the comparer 122. Note that since the first data item and the second data item are image data items in this embodiment, the first predicted data item is also an image data item.

### Neural Network 121

The neural network 121 predicts the first predicted data item that is a data item the first time after the input first data item. In the following description, the neural network 121 includes a recurrent neural network; however, the neural network 121 is not limited to the neural network 121 including a recurrent neural network. The neural network 121 may be any neural network capable of handling time-series data. Specifically, the neural network 121 is a neural network having performed learning and including a recurrent neural network. Upon receiving the current frame, the neural network 121 predicts a predicted frame that is a frame the first time after the current frame. Since the neural network 121 is capable of unsupervised learning and does not need training data with a solution label, the neural network 121 has the advantage that the size of data used as the training data is not limited.

In more detail, for example, the neural network 121 may have at least one convolutional layer and at least one convolutional LSTM. In this case, the at least one convolutional LSTM corresponds to the recurrent neural network described above. The LSTM is a model capable of learning long-term time-series data and is a type of recurrent neural network. In the convolutional LSTM, the connection of LSTM is changed from total connection to convolution. In other words, the convolutional LSTM is a LSTM in which the inner product of weighting and a state variable is changed to convolution.

In addition, for example, the neural network 121 may be the Pred Net disclosed in Lotter (ibid.) described above. In this case, the convolutional LSTM included in the Pred Net corresponds to the above-described recurrent neural network. The following description assumes that the neural network 121 in this embodiment is the Pred Net.

The structure and the like of the Pred Net will be described briefly.

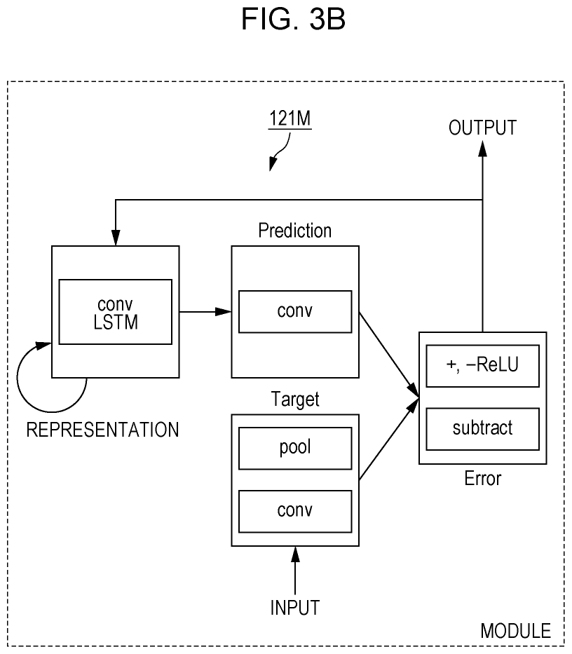

FIG. 3A is a diagram illustrating the structure of a network model of the Pred Net and information flow. FIG. 3B is a diagram illustrating one of module structures 121M that corresponds to one layer of the Pred Net.

The Pred Net has convolution and a LSTM in combination with each other. More specifically, as illustrated in FIG. 3A, the Pred Net has a hierarchical structure in which the module structures 121M as illustrated in FIG. 3B are stacked on top of each other. The Pred Net performs prediction in each layer unlike a deep neural network in the related art.

In the module structure 121M illustrated in FIG. 3B, cony denotes a convolutional layer, pool denotes a pooling layer, and cony LSTM denotes a convolutional LSTM. A module that performs prediction is cony LSTM. Target in a lower part of the module structure 121M outputs the feature of an input image to Error, and Prediction in the upper part outputs, to Error, the feature of an image predicted by cony LSTM. Error outputs a difference between the feature of the input image and the feature of a predicted image to cony LSTM and the outside of the module. For example, Error in the zeroth layer outputs the difference to cony LSTM in the zeroth layer and to Target in the lower part of the first layer. In other words, Error propagates the feature of a part that is not predicted by cony LSTM to the next layer.

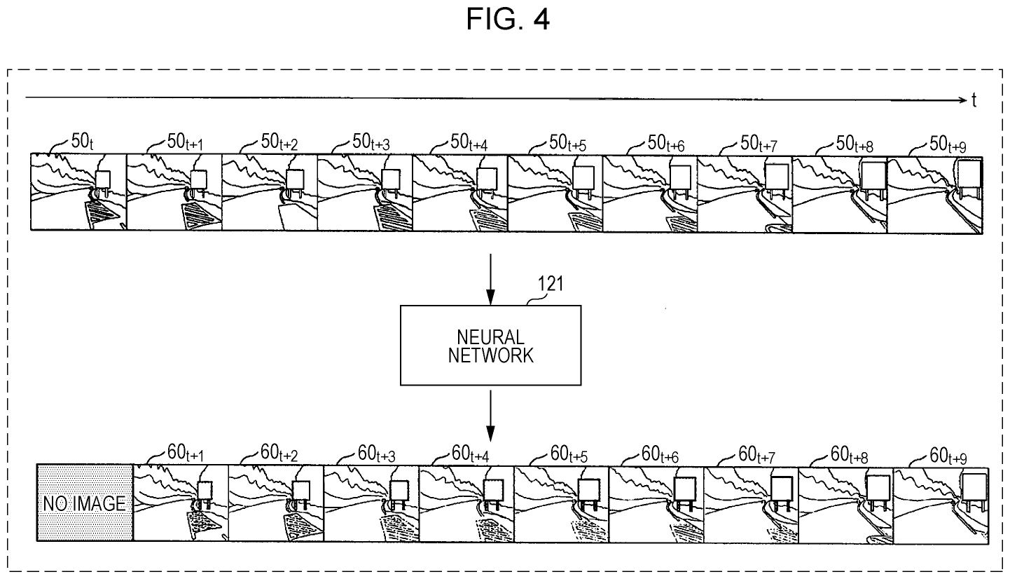

FIG. 4 is a diagram illustrating an example result of prediction by the neural network 121 in this embodiment. As described above, the neural network 121 in this embodiment is the Pred Net. A first image 50ₜ, a first image 50ₜ₊₁, . . . , and a first image 50ₜ₊₉ that are actual image data items and continuous in a time series are each input in order as the current frame in the neural network 121 illustrated in FIG. 4. The neural network 121 predicts predicted image data items one by one in order. In the example illustrated in FIG. 4, the neural network 121 in this embodiment predicts, from the actual image data items input in order, a first predicted image 60ₜ₊₁, . . . , and a first predicted image 60ₜ₊₉ that are predicted image data items. Note that, for example, the first image 50ₜ₊₁ and the first predicted image 60ₜ₊₁ are image data items at the same time(t+1). The first predicted image 60ₜ₊₁ is an image data item predicted from the first image 50ₜ by the neural network 121.

When the upper image group and the lower image group illustrated in FIG. 4, that is, the first image 50ₜ₊₁ to the first image 50ₜ₊₉ and the first predicted image 60ₜ₊₁ to the first predicted image 60ₜ₊₉ are compared, it is understood that the image groups are highly similar to each other despite the blurriness of the first predicted image 60ₜ₊₁ to the first predicted image 60ₜ₊₉. It is also understood that the first predicted image 60ₜ₊₁ to the first predicted image 60ₜ₊₉ are highly similar to each other.

As described above, in predicted frames predicted by the neural network 121, each predicted frame also highly correlates with a temporally preceding predicted frame. Specifically, if a video scene input in the neural network 121 is not considerably changed, a predicted future frame is similar to the current frame of the input video and to a predicted frame temporally slightly preceding a future frame. When a driver drives a vehicle on the highway, a scene expected by the driver every second is not really different from a scene that is experienced by the driver and that immediately precedes the expected scene and, actually, is not really different in many cases. Accordingly, the neural network 121 can predict a future frame easily and accurately from the current frame and a predicted frame temporally slightly preceding the future frame.

Note that the neural network 121 predicts one second data item from one input first data item in the description; however, the prediction is not limited to this. From one input first data item, the neural network 121 may predict two temporally consecutive data items following the first data item. More specifically, the neural network 121 may predict a first predicted data item and a second predicted data item. The first predicted data item is a data item the first time after the input first data item. The second predicted data item is a data item second time after the first data item. The second time is time the first time after the first time. Further, from one input first data item, the neural network 121 may predict three or more temporally consecutive data items following the first data item. In this case, the later a data item is predicted, the more blurred the data item is.

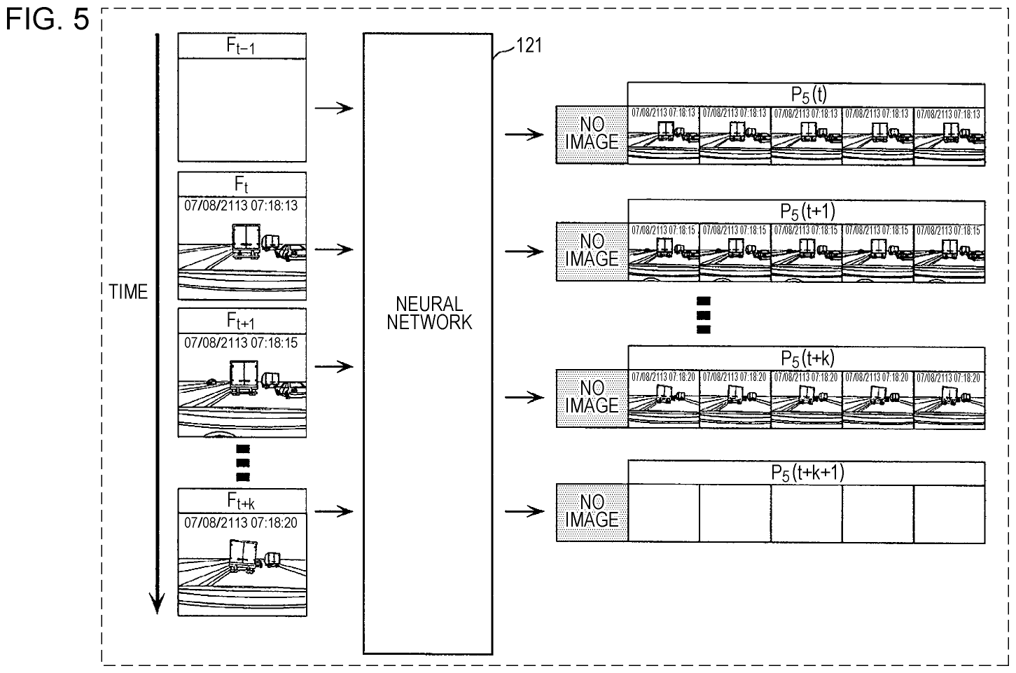

FIG. 5 is a diagram illustrating an example result of the prediction by the neural network 121 in this embodiment. As described above, the neural network 121 in this embodiment is a Pred Net. A first image Fₜ₋₁, a first image Fₜ, a first image Fₜ₊₁, . . . and a first image Fₜ₊ₖ that are continuous in a time series are each input in order as the current frame that is an actual image data item in the neural network 121 illustrated in FIG. 5. The neural network 121 predicts three or more predicted image data items in order. In the example illustrated in FIG. 5, the neural network 121 predicts, from each actual image data item, a first predicted image P₅(t), a first predicted image P₅(t+1), . . . , a first predicted image P₅(t+k), and a first predicted image P₅(t+k+1) each of which includes five predicted image data items.

### Comparer 122

The comparer 122 compares the first predicted data item output by the neural network 121 with the second data item that is included in the time-series data and that is a data item the first time after the first data item. For example, the comparer 122 may perform the comparison by using an error between the second data item and the first predicted data item or may determine whether the error between the second data item and the first predicted data item is larger than a threshold.

In this embodiment, the comparer 122 compares a predicted frame output by the neural network 121 with a second image data item that is a current frame included in the time-series data and that is a data item the first time after a first image data item. The first image data item is a current frame input to predict the predicted frame. Specifically, the comparer 122 may perform the comparison by using an error between the second image data item and the predicted frame or may determine whether the error is larger than a predetermined threshold.

The meaning of the determination of whether the error is larger than the threshold will be described.

As described above, when the driver drives the vehicle on the highway, the scene expected by the driver every second is not really different from the scene that is experienced by the driver and that immediately precedes the expected scene and, actually, is not really different in many cases. In such a case, the error is smaller than or equal to the threshold. In contrast, when the driver drives the vehicle on the highway, and when an accident attributable to another person occurs, the driver does not expect the occurrence of the accident and thus is surprised. In such a case, the error is larger than the threshold. The second image data item represents the occurrence of the accident, while the predicted image data item does not represent the occurrence of the accident. Accordingly, the error is larger than the threshold. As described above, although a near future frame is not predictable, the error between the predicted frame and the second image data item that is larger than the threshold indicates that a symptom immediately before the occurrence of the accident that is an unexpected situation can be exhibited as a scene largely different from the immediately preceding scene. The comparer 122 compares each of predicted frames with a corresponding one of second image data items continuously in a time series, and intervals continuous in a time series in video are each shorter than or equal to 0.033 seconds (longer than or equal to 30 frames per second (fps)). As described above, the comparison processor 12 can determine a symptom immediately before the occurrence of an accident by determining whether an error is larger than the threshold and can thus predict the occurrence of the accident.

Note that the description above assumes that the neural network 121 predicts one second data item from one input first data item; however, the prediction is not limited to this. From one input first data item, the neural network 121 may predict two temporally consecutive data items following the first data item. In this case, the comparer 122 may perform comparison among a first predicted data item, a second predicted data item, and a third data item. The second predicted data item is predicted by the neural network 121 as a data item the second time after the first data item. The second time is time the first time after the first time. The third data item is included in time-series data and is a data item the second time after the first data item. More specifically, the comparer 122 may perform the comparison by using an average of an error between a second data item and the first predicted data item and an error between the third data item and the second predicted data item or may determine whether the average of the errors is larger than a threshold.

Hereinafter, a comparison process executed by the comparer 122 will be described specifically by using the result of the prediction by the neural network 121 illustrated in FIG. 5.

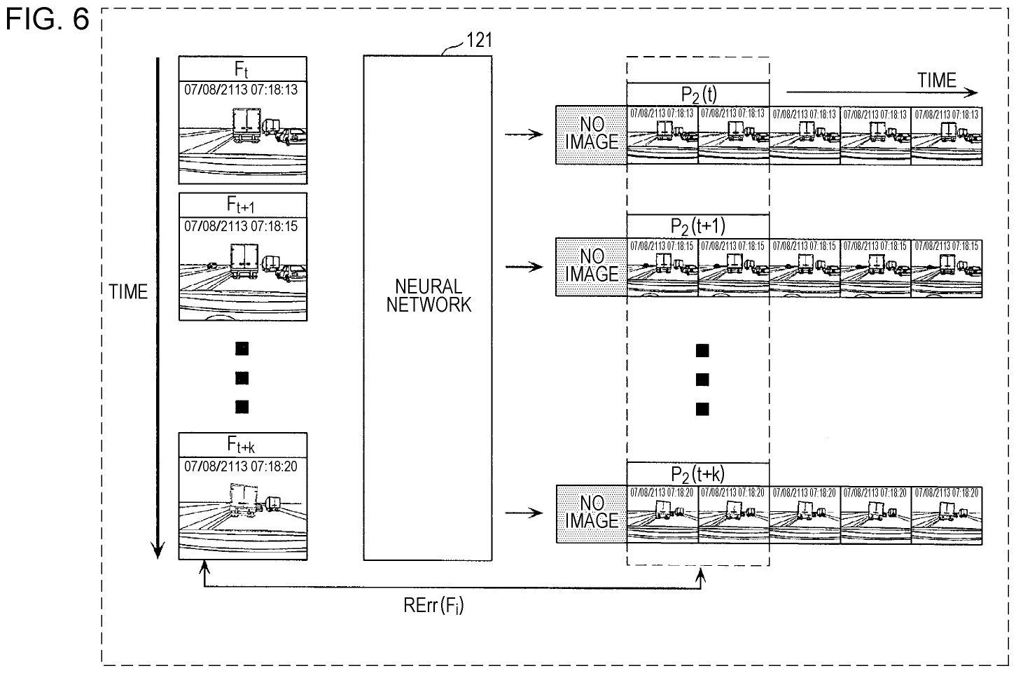

FIG. 6 is a diagram for explaining an example of a comparison process executed by the comparer 122 in this embodiment. The same components as those in FIG. 5 are denoted by the same reference numerals, and detailed explanation thereof is omitted.

In the example illustrated in FIG. 6, the comparer 122 executes the comparison process by using a first predicted image P₂(t), . . . , and a first predicted image P₂(t+k) each of which includes the first two data items of the data items in a corresponding one of the first predicted image P₅(t), . . . , and the first predicted image P₅(t+k) that are predicted by the neural network 121.

More specifically, the comparer 122 first calculates an error between a first predicted image data item in the first predicted image P₂(t) and a second image Fₜ and an error between the last predicted image data item in the first predicted image P₂(t) and a second image Fₜ₊₁. The comparer 122 then averages the errors. Likewise, the comparer 122 then calculates an error between the first predicted image P₂(t+1) and the second image Fₜ₊₁ and an error between the first predicted image P₂(t+1) and a second image Fₜ+2. The comparer 122 then averages the errors. Since subsequent steps in the comparison process are performed in the same manner, description thereof is omitted.

For example, the comparer 122 calculates an error RErr in accordance with Formula (1) and thereby executes the comparison process described above. In Formula (1), n denotes the number of used predicted frames. In the example illustrated in FIG. 6, n is 2. In addition, MSE denotes a mean square error.

$$RErr ( Fi ) = \frac{{\sum }_{t = i - n + 1}^{i} M S E ( {F}_{t} , {P}_{n} ( t ) )}{n} \qquad ( 1 )$$

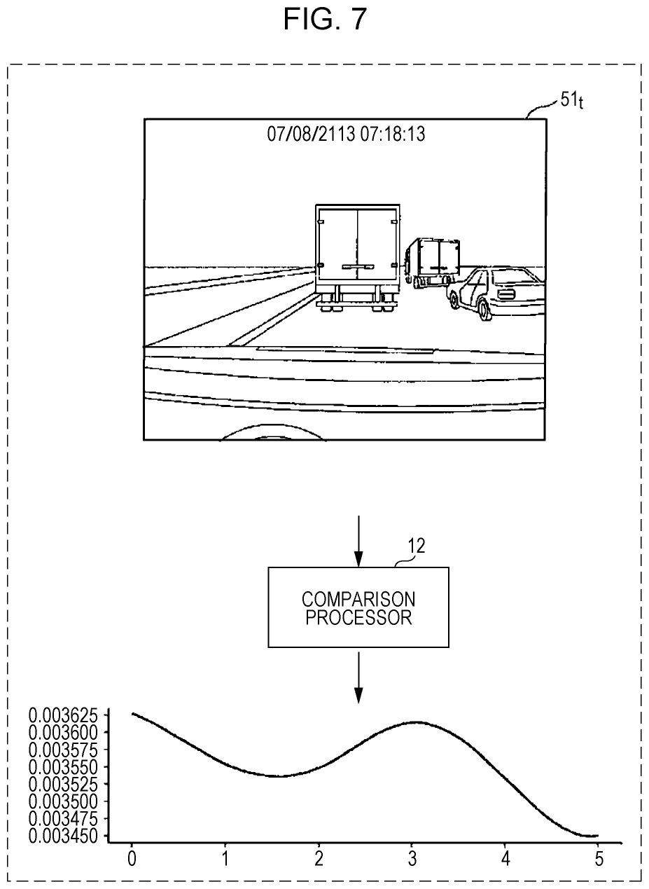

The comparer 122 executes the comparison process by calculating the error RErr in Formula (1) and outputs the calculated error RErr. A correlation between the error and a risk situation that is an unexpected situation in this case will be described by using FIGS. 7 to 10.

FIGS. 7 to 10 are each a diagram illustrating an example of an error output as the result of the comparison process executed by the comparison processor 12 in this embodiment. The horizontal axis in each of FIGS. 7 to 10 represents a numerical value as a normalized an error. FIGS. 7 to 10 illustrate that the error is increased as the numerical value is increased. A second image 51ₜ, a second image 51ₜ₊₁, a second image 51ₜ₊₂, and a second image 51ₜ₊₃ that are respectively illustrated in FIGS. 7 to 10 are each an example of the second image data item and each represent a frame sampled from frames continuous in a time series and included in video in which an accident occurs in one of the frames.

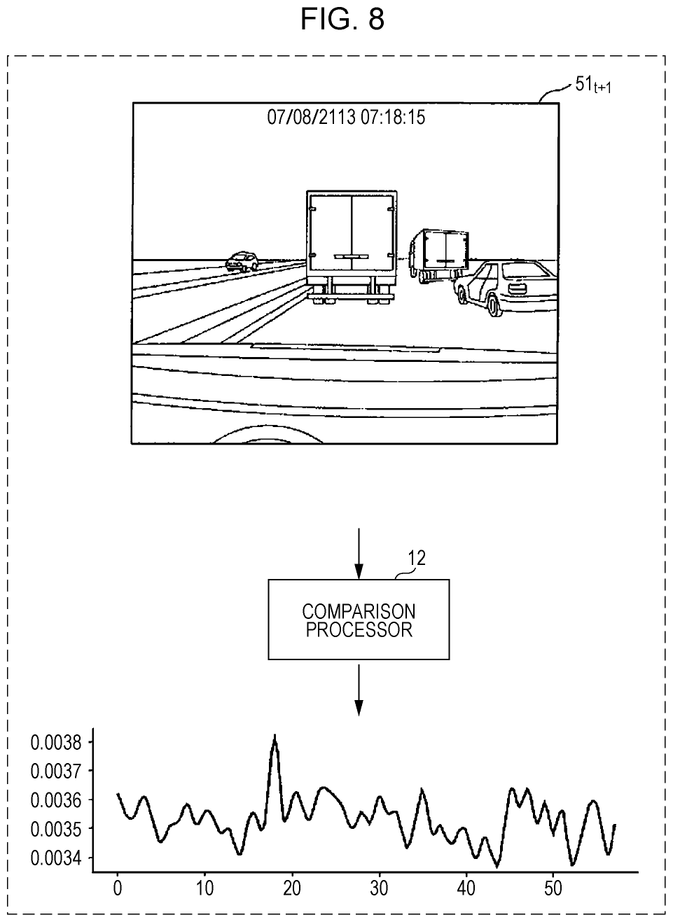

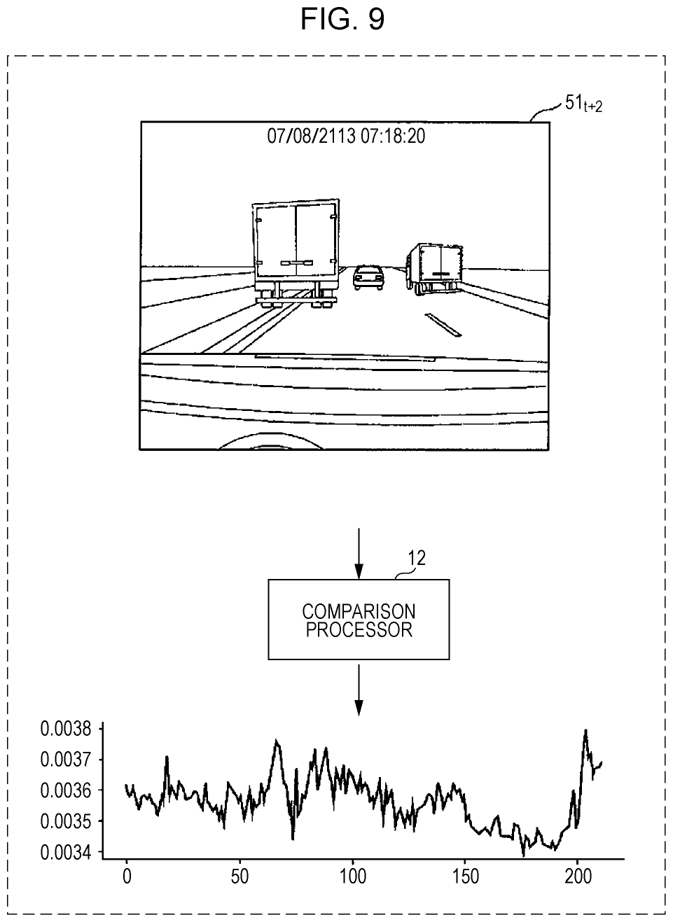

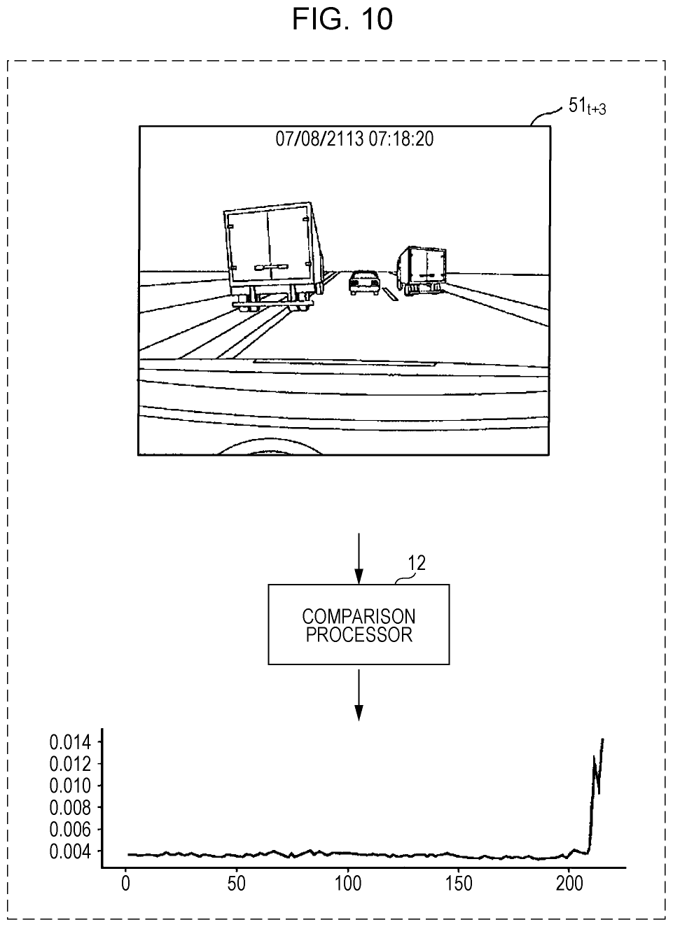

FIG. 7 illustrates the second image 51ₜ and an error RErr with respect to a predicted image predicted from a first image that is a frame one frame temporally preceding the second image 51ₜ. Likewise, FIG. 8 illustrates the second image 51ₜ₊₁ and an error RErr with respect to a predicted image predicted from a first image that is a frame one frame temporally preceding the second image 51ₜ₊₁. FIG. 9 illustrates the second image 51ₜ₊₂ and an error RErr with respect to a predicted image predicted from a first image that is a frame one frame temporally preceding the second image 51ₜ₊₂. FIG. 10 illustrates the second image 51ₜ₊₃ and an error RErr with respect to a predicted image predicted from a first image that is a frame one frame temporally preceding the second image 51ₜ₊₃.

As illustrated by the second image 51ₜ₊₁ in FIG. 8, the truck in front of the vehicle driven by the driver is out of control and starts sliding laterally. It is understood that the error RErr is drastically increased at this time compared with the error RErr illustrated in FIG. 7. It is also understood that after the truck in front of the vehicle runs onto the shoulder of the road, that is, after an actual accident occurs in the second image 51ₜ₊₃ in FIG. 10, the error RErr becomes flat. These prove that the error RErr is drastically increased immediately before the occurrence of the actual accident. Accordingly, it is understood that if time when the error RErr immediately before the occurrence of the actual accident starts increasing is determined by determining whether the error RErr is larger than the threshold, the occurrence of the actual accident can be predicted slightly before the occurrence of the accident.

### Outputter 13

If the error between the second data item and the first predicted data item is larger than the threshold as a result of the comparison by the comparison processor 12, the outputter 13 outputs information indicating warning. Note that the outputter 13 may output the warning information by emitting light, sounding an alarm or the like, displaying an image, operating a predetermined object such as an alarm lamp, or stimulating any of five senses by using smell or the like. Any information indicating warning may be used.

When the comparison processor 12 outputs, as a comparison result, an error value represented by Formula (1), and if the error between the second data item and the first predicted data item is larger than the threshold, the outputter 13 may also output the information indicating warning.

The comparison processor 12 may also output, as the comparison result, the average value of the error between the second data item and the first predicted data item and the error between the third data item and the second predicted data item. In this case, if the average of the error between the second data item and the first predicted data item and the error between the third data item and the second predicted data item is larger than the threshold, the outputter 13 may output the information indicating warning. As described above, if a plurality of sets of a predicted data item and an actual data item are compared, an unexpected situation can be predicted accurately, and thus the robustness of the information indicating warning is enhanced.

When a situation unexpected in time-series data such as video input by the inputter 11 is to occur, the outputter 13 can output the warning information in this manner.

### Operation of Information Processing Apparatus 10

Hereinafter, an example of the operation of the information processing apparatus 10 configured as described above will be described.

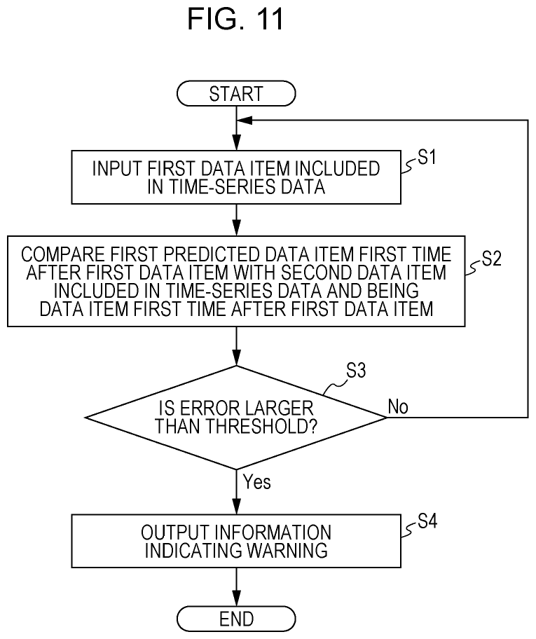

FIG. 11 is a flowchart for explaining the operation of the information processing apparatus 10 in this embodiment.

First, the computer of the information processing apparatus 10 inputs, in the neural network 121, a first data item that is one of data items included in time-series data (S1). In this embodiment, the computer of the information processing apparatus 10 inputs the first data item as the current frame in the neural network 121. The first data item is one of frames included in video. The neural network 121 includes a recurrent neural network.

The computer of the information processing apparatus 10 then compares a first predicted data item predicted by the neural network 121 as a data item the first time after the first data item with a second data item that is included in the time-series data and that is a data item the first time after the first data item (S2). In this embodiment, the computer of the information processing apparatus 10 causes a Pred Net that is the neural network 121 to predict, as a predicted frame, a frame one frame temporally following the current frame. The computer of the information processing apparatus 10 performs the comparison by using an error between a second frame and the predicted frame. The second frame is an actual frame one frame temporally following the current frame.

The computer of the information processing apparatus 10 determines, as a comparison result, whether the error between the second data item and the first predicted data item is larger than the threshold (S3). In this embodiment, the computer of the information processing apparatus 10 determines whether the error between the second frame and the predicted frame is larger than the predetermined threshold.

If the error between the second data item and the first predicted data item is larger than the threshold in step S3 (Yes in S3), the computer of the information processing apparatus 10 outputs information indicating warning (S4). If the calculated error between the second data item and the first predicted data item is smaller than or equal to the threshold in step S3 (No in S3), the computer of the information processing apparatus 10 returns to step S1.

In this embodiment, if the error between the second frame and the predicted frame is larger than the threshold, the computer of the information processing apparatus 10 outputs warning indicating the occurrence of an unexpected situation such as a state immediately before the occurrence of an accident.

As described above, the information processing apparatus and the like in this embodiment uses the neural network including the recurrent neural network and having performed unsupervised learning and can thereby predict a future data item from a first data item that is one of data items included in time-series data. The predicted data item that is the future data item has a characteristic of having high similarity to a temporally slightly preceding data item. Accordingly, the information processing apparatus and the like in this embodiment can determine time when an unpredicted state occurs by comparing a future data item predicted by the neural network with an actual data item at the time corresponding to the time of the predicted data item. As described above, the information processing apparatus and the like in this embodiment can predict a risk situation by determining the time when the unpredicted state occurs.

Note that if the time-series data is data regarding image taking performed with an onboard camera for a place in front of an automobile, the unpredicted state is a state different from the immediately preceding scene and is, for example, a state immediately before the occurrence of an accident. If the time-series data is data regarding image taking performed with a monitoring camera for a predetermined space or the flow of people, the unpredicted state is a state different from the immediately preceding state of the space or flow of people and also is a state immediately before a crime, trouble, or the like indicated by an abnormal activity such as invasion into the predetermined space or a change of the flow of people. As described above, determining the unpredicted state corresponds to predicting a risk situation.

If the time-series data is data regarding two people's conversation continuous in a time series, the unpredicted state may be a state different from the immediately preceding state, such as a third party's joining the conversation. If the time-series data is sound data regarding a predetermined place and continuous in a time series, the unpredicted state may be a state different from the immediately preceding state, such as time when a scream, a roar, or a groan occurs.

As described above, the information processing apparatus and the like in this embodiment can predict a risk situation by using a neural network.

The information processing apparatus in this embodiment is applicable to risk situation prediction in fields of, for example, an advanced driver assistance system (ADAS), automatic driving, and a monitoring system.

Further, when the information processing apparatus in this embodiment is applied to a monitoring system, a guard can be alerted when an unpredicted state occurs, and thus boring human work of continuously monitoring a security camera to detect an abnormal activity can be reduced.

### OTHER POSSIBLE EMBODIMENTS

The present disclosure is not limited to the embodiment described above. For example, an embodiment implemented by any combination of the components described herein or exclusion of any of the components may be an embodiment of the present disclosure. The present disclosure also includes a modification obtained by various variations of the above-described embodiment conceived of by those skilled in the art without departing from the spirit of the present disclosure, that is, the meaning represented by the wording in the scope of claims.

The present disclosure further includes the following cases.

(1) The above-described apparatus is specifically a computer system including a microprocessor, a ROM, a random-access memory (RAM), a hard disk unit, a display unit, a keyboard, a mouse, and other components. The RAM or the hard disk unit stores a computer program. The microprocessor operates in accordance with the computer program, and each component implements the function thereof. The computer program is configured by combining a plurality of instruction codes each indicating an instruction to the computer to implement a predetermined function.

(2) Part or all of the components of the above-described apparatus may be included in a system large scale integration (LSI) circuit. The system LSI circuit is an ultra multifunction LSI circuit manufactured by integrating a plurality of components on one chip and is specifically a computer system including a microprocessor, a ROM, a RAM, and other components. The RAM stores a computer program therein. The microprocessor operates in accordance with the computer program, and thereby the system LSI circuit implements the function thereof.

(3) Part or all of the components of the above-described apparatus may be included in an IC card attachable to or detachable from each component or may be included in a single module. The IC card or the module is a computer system including a microprocessor, a ROM, a RAM, and other components. The IC card or the module may include the ultra multifunction LSI circuit described above. The microprocessor operates in accordance with a computer program, and thereby the IC card or the module implements the function thereof. The IC card or the module may have tamper resistance.

(4) The present disclosure may be the method described above. The method may be a computer program run by a computer and may be a digital signal generated by the computer program.

(5) The present disclosure may be a computer readable recording medium storing the computer program or the digital signal, such as a flexible disk, a hard disk, a CD-ROM, a magneto-optical disk (MO), a digital video disk (DVD), a DVD-ROM, a DVD-RAM, a Blu-ray (registered trademark) disc (BD), or a semiconductor memory. The present disclosure may be a digital signal recorded in any of these recording media.

The present disclosure may be an object that transmits the computer program or a digital signal through an electrical communication line, a wireless or a wired communication line, a network represented by the Internet, data broadcasting, or the like.

The present disclosure may be a computer system including a microprocessor and a memory. The memory may store the computer program described above, and the microprocessor may operate in accordance with the computer program.

The present disclosure may be implemented by an independent different computer system in such a manner that a computer program or a digital signal is recorded in a recording medium and thereby transferred or in such a manner that the computer program or the digital signal is transferred via a network or the like.

The present disclosure is usable for an information processing apparatus and an information processing method that use a neural network and is particularly usable for an information processing apparatus and an information processing method that are for predicting a risk situation in the field of ADAS, automatic driving, or a monitoring system.

What is claimed is:

1. An information processing apparatus comprising:
an inputter that inputs, in a neural network, a first data item that is one of data items included in time-series data;
a comparison processor that performs comparison between a first predicted data item predicted by the neural network and a second data item included in the time-series data, the first predicted data item being predicted as a data item first time after the first data item, the second data item being a data item the first time after the first data item; and
an outputter that outputs information indicating warning if an error between the second data item and the first predicted data item is larger than a threshold after the comparison processor performs the comparison.

2. The information processing apparatus according to claim 1,
wherein the time-series data is video data, and
wherein the first data item, the first predicted data item, and the second data item are image data items.

3. The information processing apparatus according to claim 1,
wherein the comparison processor performs comparison among the first predicted data item, a second predicted data item, and a third data item that is included in the time-series data, the second predicted data item being predicted by the neural network as a data item second time after the first data item, the second time being time the first time after the first time, the third data item being a data item the second time after the first data item, and
wherein if an average of the error between the second data item and the first predicted data item and an error between the third data item and the second predicted data item is larger than a threshold after the comparison processor performs the comparison, the outputter outputs the information.

4. The information processing apparatus according to claim 2,
wherein the neural network includes a recurrent neural network.

5. The information processing apparatus according to claim 4,
wherein the neural network has
at least one convolutional long-short-term-memory (LSTM) and
at least one convolutional layer, and
wherein the at least one convolutional LSTM is the recurrent neural network.

6. The information processing apparatus according to claim 4,
wherein the neural network is a deep predictive coding network (Pred Net), and
wherein the recurrent neural network is a convolutional long-short-term-memory (LSTM) included in the Pred Net.

7. An information processing method performed by a computer by using a neural network, the method comprising:
inputting, in the neural network, a first data item that is one of data items included in time-series data;
performing a comparison process in which comparison between a first predicted data item predicted by the neural network and a second data item that is included in the time-series data is performed, the first predicted data item being predicted as a data item first time after the first data item, the second data item being a data item the first time after the first data item; and
outputting information indicating warning if an error between the second data item and the first predicted data item is larger than a threshold after the comparison is performed in the performing of the comparison process.
